(19) United States
(12) Patent Application Publication
(10) Pub. No.: US 2002/0023017 A1
(43) Pub. Date: Feb. 21, 2002

(54) Sales management system, sales management server, sales server, reservation management server, product purchase terminal, product sales method and storage medium

(75) Inventors: Kazuyoshi Hidaka, Yokohama-shi (JP); Yuhichi Nakamura, Yokohama-shi (JP); Takashi Toyooka, Kawasaki-shi (JP)

Correspondence Address: IBM CORPORATION, INTELLECTUAL PROPERTY LAW DEPT., P.O. BOX 218, YORKTOWN HEIGHTS, NY, 10598, US

(73) Assignee: International Business Machines Corporation, Armonk, NY

(21) Appl. No.: 09/884,698

(22) Filed: Jun. 19, 2001

(30) Foreign Application Priority Data
Jul. 31, 2000 (JP) 2000-232305

(51) Int. Cl. G06F 17/60

(52) U.S. Cl. 705/26

(57) ABSTRACT

It is one object of the present invention to provide a system whereby a vendor selling products via a network can redeem products from purchasers in accordance with predetermined conditions.

Constitution

In a sales management server including a ticket sales system 10, for accepting a product purchase request via a communication network, and a ticket management system 30, for managing the sale of products, upon the receipt of a purchase request from a purchase applicant, the ticket sales system 10 inquires of the purchase applicant whether he or she will agree to permit redemption of the product. When a product for a predetermined purchase request accepted by the ticket sales system 10 has already been sold to a purchaser who responded that he or she agreed to permit product redemption, the ticket management system 30 redeems the product and provides it for the purchase applicant who issued the predetermined purchase request.

### DETAILED DESCRIPTION OF THE INVENTION

1. Field of the Invention

The present invention relates to a business trading system, such as the sale of tickets or the arrangement and acceptance of reservations, for which a communication network is employed.

2. Background Art

Presently, wide spread use is made of communication networks, such as the Internet, for electronic commerce. And increasingly, such communication networks are especially being used for trades involving the purchase and assignment of specific rights, including the sale of tickets for transportation, such as for airplanes, and for movies, plays and sports events, or the arrangement and acceptance of hotel reservations. This is true because to provide appropriate management for the objective of such a transaction (the assignment of a specific right or the sale of a ticket to a named person) electronic information will suffice.

For such a transaction, the limitations imposed on the conditions established for the trade will differ, depending on the purchaser. For the sale of a flight ticket, for example, one purchaser will insist that everything, to include the scheduled date and time and the type of airplane and seat, be stipulated, whereas another purchaser will be satisfied if only a roughly scheduled date is established. Assume that there is one purchaser, A, who desires a flight ticket for which specific conditions are prerequisite, and that there is another purchaser, B, who has already purchased a flight ticket matching the conditions established by purchaser A but for whom strict compliance with the terms of the sale are moot, in this case, if the flight ticket previously contracted for by purchaser B is assigned to purchaser A, and an adequate substitute flight ticket is provided for purchaser B, while purchaser B is not placed at a very great disadvantage, purchaser A can obtain a flight ticket that he or she might not have been able to acquire by another method.

Conventionally, in order to assign to purchaser A a flight ticket contracted for by purchaser B, the two purchasers must directly interact with each other, or an agency must render that service for them.

Problems to be Solved by the Invention

However, either when purchasers jointly participate in a trade for a product, or when an agency renders the service, a satisfactory replacement product can not always be provided for purchaser B, and thus, a trade can not always be smoothly performed.

Further, it is not always easy to find a purchaser B who has contracted for a product requested by a purchaser A.

It is, therefore, one object of the present invention to provide a system whereby under predetermined conditions a vendor can redeem a product contracted for by a purchaser. As a result, the sale of products can be performed efficiently.

It is another object of the present invention to provide means whereby a purchaser who has sought only an uncomplicated condition for a purchased product can obtain a predetermined privileged condition based on the exchange of a purchased product for a replacement.

### SUMMARY OF THE INVENTION

To achieve these objects, according to the present invention, a sales management system having the following configuration is provided. Such a sales management system comprises: a sales server for vending products via a communication network; and purchase terminals for accessing the sales server via a communication network and transmitting product purchase requests, wherein for a purchase terminal transmits, to the sales server, not only a product purchase request but also a purchaser issued product redemption status statement permitting or not permitting product redemption, wherein the sales server manages information concerning the terms of a sale of a product, to include a product redemption status statement, and wherein when the sales server receives, from a purchaser, a predetermined purchase request for a product the sales server had previously agreed to supply, in response to a previous purchase request received from a previous purchase terminal, to a previous purchaser who, in an affiliated product redemption status statement, agreed to permit product redemption, the sales server can redeem the product from the previous purchaser and supply the product to the purchaser who has submitted the predetermined purchase request.

The previous purchase terminal transmits to the sales server not only the statement in which the previous purchaser agrees to permit product redemption, but a listing of conditions governing the redemption of the product. After the conditions governing the redemption of the product have been satisfied, the sales server can redeem the product.

Arbitrary conditions governing the redemption of a product can be determined in accordance with the type of product or with the conditions originally established for the purchase of the product by an applicant.

According to the present invention, a sales management system may have the following configuration. A sales management system comprises: a management server for managing product sales information; and product sales terminals for transmitting to the management server, via a communication network, requests for the purchase of products to ascertain the sales status of the products, and for selling the products when the products are available, wherein the product sales terminals transmit to the management server not only the product purchase requests but also purchaser issued product redemption status statements agreeing or not agreeing to permit product redemption, wherein the management server manages the product redemption status statements received from the product sales terminals, and wherein when the management server receives, from a product sales terminal, a predetermined purchase request submitted by a purchase applicant for a product the sales management server has previously agreed to supply, in response to a purchase request, to a previous purchaser, who agreed to permit product redemption, the management server redeems the product from the previous purchaser, and is ready to sell the product to the purchase applicant who issued the predetermined purchase request.

The product sales terminals transmit, to the management server, not only statements in which purchasers agree to permit product redemption, but also conditions governing the redemption of products. After the conditions governing the redemption of the products have been satisfied, the management server can redeem the products.

According to the present invention, a sales management server comprises: purchase request acceptance means for accepting product purchase requests via a communication network; and management means for managing the sale of products, wherein the sales management server, upon acceptance of a product purchase request from a purchase applicant, inquires of the purchase applicant whether the purchase applicant will agree to permit the redemption of a product for which the purchase request was submitted, and wherein when the sales management server receives a predetermined product purchase request from a purchase applicant for a product the sales management server has previously agreed to supply, in response to a purchase request, to a previous purchaser, who agreed to permit product redemption, the management means redeems the product from the previous purchaser and supplies the product to the purchase applicant who issued the predetermined purchase request.

The purchase request acceptance means receives not only a reply to an inquiry to determine whether the purchaser will agree to permit product redemption, but also conditions governing the redemption of the product. After the conditions governing the redemption of the product have been satisfied, the management means redeems the product.

When the product is redeemed, predetermined privileges are provided for the purchaser who permitted product redemption, and the management means manages information concerning the privileges.

The management means can dynamically change the information concerning the privileges provided in accordance with predetermined conditions. For example, when a product is a flight ticket or a sports function ticket, as the date, such as the boarding date or the game date, is neared whereat a holder may exercise the right granted by the ticket, the privileges afforded the purchaser who has granted product redemption permission may be increased, while taking into account the inconvenience the purchase applicant will suffer. Further, even when the redemption of a product does not actually take place, predetermined privileges can also be provided, in accordance with the redemption conditions, a purchaser who has agreed to permit product redemption.

According to the present invention, a sales management server for managing the sale of products comprises: storage means for storing information indicting whether a purchaser of a product has agreed to permit product redemption; and management means for receiving, via a communication network, information concerning a predetermined product purchase request, and for, based on the information stored the storage means when it is ascertained that a product for which the predetermined purchase request was submitted is a product for which a purchaser has agreed to permit product redemption, redeeming the product from the purchaser.

The storage means stores not only the information indicating that a purchaser has agreed to permit product redemption, but also conditions governing the redemption of the product. After the conditions for governing the redemption of the product have been satisfied, the management means can redeem the product.

According to the present invention, a sales management server comprises: purchase request acceptance means for accepting, via a communication network, product purchase requests; and management means for managing the sale of products, wherein when the purchase request acceptance means accepts a product purchase request, the purchase request acceptance means inquires of the purchase applicant, who issued the purchase request, whether the purchase applicant will agree to permit the substitution, for a product for which the purchase request was submitted, of a different product, and accepts conditions governing the provision of a replacement product, and wherein when a product for which a predetermined purchase request is submitted and accepted by the purchase request acceptance means has already been provided for a purchaser who has agreed to permit a product exchange, and when the management means determines that a replacement product, which satisfies the conditions governing a product exchange, is available for supply to the purchaser, the management means exchanges the replacement product for the product originally obtained by the purchaser.

According to the present invention, a reservation management server comprises: reservation acceptance means for accepting reservations via a communication network; and management means for managing the status of reservations, wherein upon acceptance of a request for a reservation the reservation acceptance means inquires of the submitter of the request whether the submitter will agree to permit a reservation change, and accepts conditions governing the agreement to permit a reservation change, wherein when the object of a reservation accepted by the reservation acceptance means is the same as that for a specific reservation that was previously approved for an applicant who agreed to permit a reservation change, and when the conditions governing the reservation change can be satisfied, the management means changes the object of the reservation made by the applicant.

According to the present invention, a product purchase terminal having the following configuration can be provided. A product purchase terminal comprises: purchase request transmission means for transmitting a purchase request to a sales management system for accepting, via a communication network, a product purchase request; input means for entering data required to issue the purchase request; and output means for presenting information required for the issue of the purchase request, wherein the input means accepts identification information indicating that a request to redeem a product for which the purchase request is submitted will be complied with, and wherein the purchase request transmission means will transmit, to the sales management system, the identification information accepted by the input means.

The input means accepts conditions for the redemption of a product, and the purchase request transmission means transmits to the sales management system the redemption conditions accepted by the input means.

Further, when the product is redeemed from a purchaser whom the identification information verifies has agreed to permit the redemption request, a predetermined privilege is provided for the purchaser. The output means presents a privilege to be provided, in accordance with the redemption conditions entered by the input means.

According to the present invention, a product sales method comprises the steps of: submitting an inquiry, via a communication network, to determine whether permission for a redemption request will be given when a purchase request for a product is accepted; accepting a response to the inquiry and selling the product; complying with and obtaining the product when a different purchase request is accepted, by redeeming the product for which redemption permission has been granted by a purchaser who responded to the redemption request inquiry; and providing the product that is redeemed to a purchase applicant who issued the different purchase request.

The step of inquiring whether the request for redemption permission will be granted includes the step of: setting conditions for the redemption of a product, and the step of redeeming the product includes the steps of: examining whether conditions for the redemption of the product have been satisfied; and redeeming the product when the product redemption conditions have been satisfied.

The step of inquiring whether the request for redemption will be granted includes the step of: setting, as a condition for the redemption of a product, the provision of a replacement product that satisfies predetermined conditions, and the step of redeeming the product includes the steps of: determining whether the replacement product that satisfies the predetermined conditions can be provided, and redeeming the product when the replacement product that satisfies the predetermined conditions can be provided.

According to the present invention, a storage medium is provided on which a computer-readable program is stored by computer input means, and permits the computer to perform: a process for accepting, via a communication network, a product purchase request; a process for inquiring, of a purchase applicant who issued the product purchase request, whether the purchase applicant will agree to permit the redemption of a product for which the purchase request is submitted; and a process for, when the purchase of the product has already been processed for sale to a purchaser who, in response to an inquiry, has agreed to permit the redemption of the product, redeeming the product from the purchaser.

### BRIEF DESCRIPTION OF THE DRAWINGS

FIG. 1 is a diagram for explaining the general structure of a sales management system according to one embodiment of the invention.

FIG. 2 is a diagram showing a redemption permitting purchaser list according to the embodiment.

FIG. 3 is a flowchart for explaining the processing for the sale and management of flight tickets according to the embodiment.

FIG. 4 is a diagram for explaining an example structure for an interface screen for the purchase of flight tickets according to the embodiment.

FIG. 5 is a diagram showing an example setup when the changing of redemption points occurs as time elapses.

### PREFERRED EMBODIMENT

The preferred embodiment of the invention will now be described in detail while referring to the accompanying drawings.

The present invention can be employed for general product trading through which specific rights are vended, and includes the sale of tickets for transportation on vehicles, such as airplanes, and for admission to movies and plays and to sports events, as well as arrangements made for hotel reservations. To simplify the explanation presented in this embodiment, the sale of flight tickets will be employed.

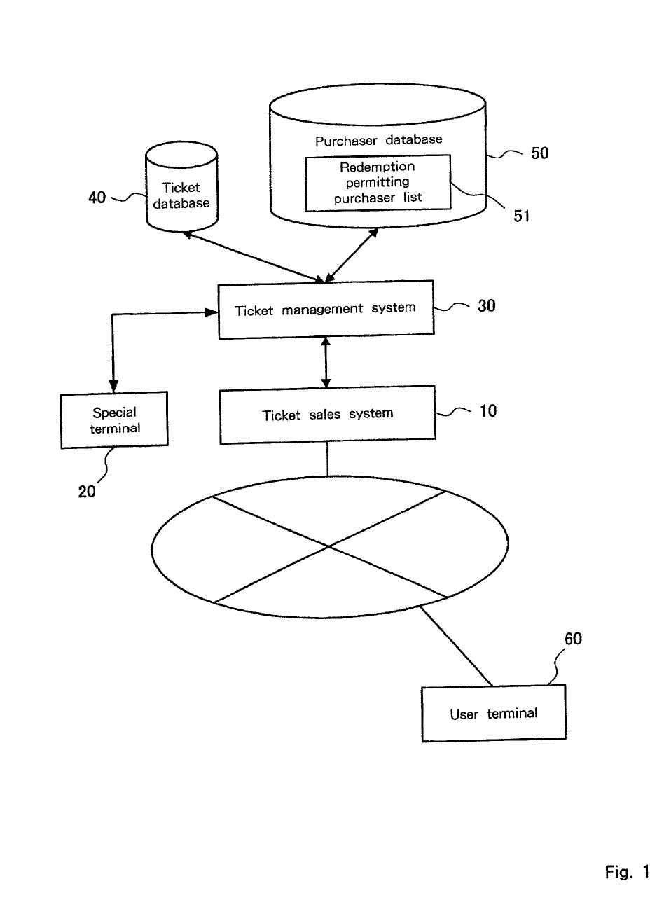

FIG. 1 is a diagram for explaining the general configuration of a sales management system according to the embodiment.

In FIG. 1, a ticket sales system 10 provides a flight ticket sales service via a communication network, such as the Internet. A special terminal 20 for selling flight tickets is operated by a special operator who provides the flight ticket sales service. A ticket management system 30 manages ticket data for flight tickets and information concerning ticket purchasers. A ticket database 40 is used by the ticket management system 30 to manage the ticket data, and a purchaser database 50 is also used to manage the information concerning the ticket purchasers. A user terminal 60 is also provided.

A prospective purchaser of a flight ticket accesses the ticket sales system 10 via the special terminal 20 operated by the special operator, or by using the user terminal 60, and purchases a desired flight ticket.

In this embodiment, the sales server, including the ticket sales system 10, the ticket management system 30, the ticket database 40 and the purchaser database 50, is located on the communication network. To access the sales server and to purchase a flight ticket by employing the user terminal 60, the communication network is used to access the ticket sales system 10. Data concerning flight tickets sold by the ticket sales system 10 are managed by the ticket management system 30.

To purchase a flight ticket from the special terminal 20, since the flight ticket sales function of the ticket sales system 10 is also included in the special terminal 20, the ticket management system 30 can be accessed directly without recourse to the ticket sales system 10 being required. Data concerning a flight ticket sold by the special terminal 20 is managed by the ticket management system 30.

When the sale of the flight tickets is performed only by the special terminal 20, or when a server possessing the function of the ticket sales system 10 is already present on the communication network, a management server, including the ticket management system 30, the ticket database 40 and the purchaser database 50, can also be located on the communication network. In this case, the management and the redemption of flight tickets sold by the special terminal 20 and the ticket sales system 10 can be provided as management server services.

In this embodiment, when only a minor condition is requested for a flight ticket that is to be purchased, i.e., when a change in an airline or a boarding date may be provided, at the time the ticket is purchased the purchaser notifies the vendor that the flight ticket can be redeemed. At this time, within a predetermined range, the purchaser can designate conditions (hereinafter referred to as redemption conditions) for the provision of a replacement for the flight ticket if it is redeemed by the vendor. These data are stored in the purchaser database 50, and the purchaser who issued the redemption conditions is registered as a purchaser who has agreed to permit the redemption of a ticket.

Assume that there is a purchase applicant who desires to purchase a flight ticket for which predetermined conditions apply, and that the flight ticket has already been sold. When the original purchaser of the flight ticket is registered as a purchaser who has agreed to permit product redemption, the flight ticket vendor can redeem the flight ticket from the purchaser with the provision that a replacement product that satisfies the redemption conditions will be provided, and can provide the redeemed flight ticket for the purchase applicant.

With this configuration, via the communication network, the ticket sales system 10 sells a flight ticket in accordance with a purchase request issued by the user terminal 60. That is, a flight ticket is issued upon the receipt of the purchase request, and a seat on the plane corresponding to the purchase request is obtained. Thereafter, the flight ticket is delivered to the purchaser (the user of the user terminal 60) by mail or other means. When the purchaser is determined to be a purchaser who has agreed to permit redemption of the ticket, the redemption conditions for the flight ticket are also entered upon the acceptance of the purchase request.

The special terminal 20 includes input means, such as a keyboard, output means, such as a display, and issuance means for issuing a flight ticket, and is operated by a special operator at an airline or a travel agency. The special operator enters information at the special terminal 20 in accordance with order instructions issued by a purchaser, and issues a flight ticket and obtains a seat on an airplane that corresponds to the order instructions. When the purchaser is determined to be a purchaser who has agreed to permit redemption of the ticket, the redemption conditions for the flight ticket are also entered upon the acceptance of the purchase request.

For flight tickets sold through the ticket sales system 10 and the special terminal 20, the ticket management system 30 manages the relevant data for the flight tickets and the purchasers. Relative data for the flight tickets, such as the flight ticket sales status and the seat occupancy status for the airplane, are stored and managed in the ticket database 40. Relative data for the purchasers of flight tickets are stored and managed in the purchaser database 50.

Information concerning redemption permitting purchasers (information indicating purchasers have agreed to permit redemption of products tendered by a vendor) is stored for corresponding products in a purchaser list 51 in the purchaser database 50.

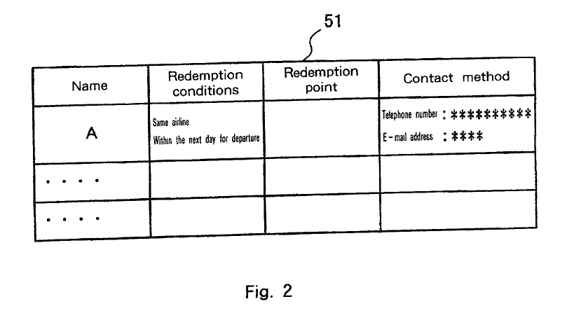

FIG. 2 is a diagram showing the redemption permitting purchaser list 51.

Referring to FIG. 2, five entries are made: the names, the redemption conditions, the points allocated for a redemption, the points awarded for a redemption registration, and the contact method.

The points allocated for a redemption refer to a value placed on privileges afforded a purchaser, who has agreed to permit product redemption, when a flight ticket is redeemed. A purchaser who agreed to permit product redemption is inconvenienced to a degree, because even though the conditions that exist when such a purchaser requests a desired flight ticket may not be overly pressing, once the flight ticket has been obtained the applicable conditions change. Therefore, privilege credits are provided for a purchaser who has agreed to permit product redemption in accordance with the redemption status, so that recompense is made for inconveniences imposed on the purchaser. Thus, a purchaser who has agreed to permit product redemption can obtain predetermined privilege credits, while at the same time exchanging the obtained product for an equivalent replacement product.

The points awarded for a redemption registration refer to privilege credits that are provided a purchaser when he or she agrees to permit product redemption. That is, regardless of whether the redemption of a product occurs, a purchaser who agreed to permit product redemption can obtain predetermined privilege credits. The value of the privilege credits that are awarded can be set in accordance with specific redemption conditions.

The type of privilege afforded can be arbitrarily determined in accordance with the objects sold. For example, for a flight ticket, points may be awarded for mileage. And of course, a predetermined amount of money may be paid. As will be described later, the points awarded for a redemption can be dynamically set as time elapses.

In the example in FIG. 2, purchaser A forwarded a notification that he or she would agree to permit product redemption under the conditions that if the flight ticket were redeemed the replacement flight ticket would be for the same airline and that the boarding date would be postponed only until the following day. Further, a telephone number and an e-mail address are the means designated for contacting purchaser A to redeem the flight ticket. The information registered in the redemption permitting purchaser list 51 is not limited to the entries in FIG. 2, and arbitrary entries can be established by a vendor in accordance with the type of product sold.

The user terminal 60 is employed by the user to issue a flight ticket purchase request to the ticket sales system 10 via the communication network. For the user terminal 60 various systems can be used that are connected to and can exchange information via the communication network, such as personal computers, PDAs or portable telephone information terminals.

To purchase a flight ticket using the user terminal 60, the user terminal 60 accesses the ticket sales system 10, via the communication network, and obtains an interface screen for the purchase of a flight ticket. The interface screen, prepared by the ticket sales system 10, takes the form of a web page that uses an HTML file, and is transmitted in response to an access initiated by the user terminal 60.

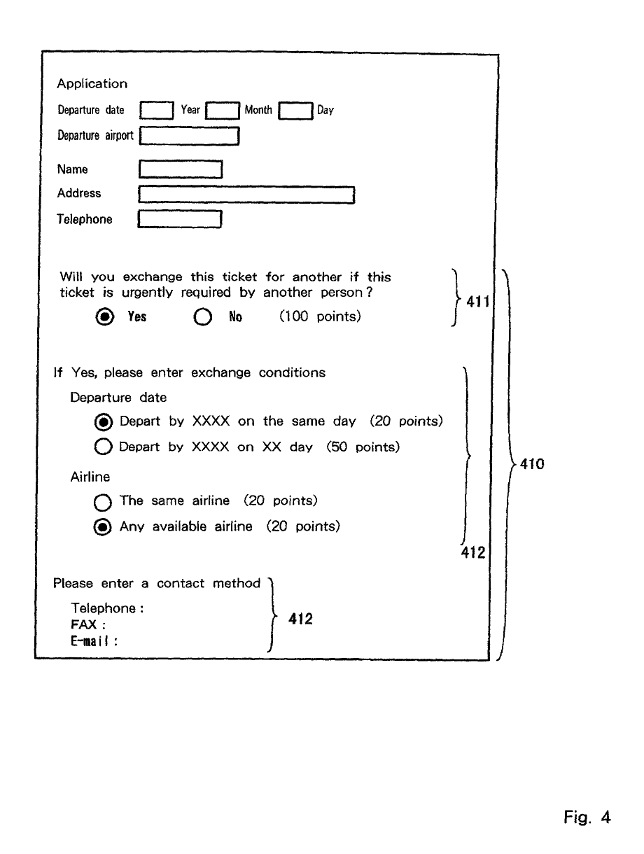

FIG. 4 is a diagram used to explain an example interface screen for the purchase of a flight ticket. Referring to FIG. 4, the interface screen includes not only conditions related to a desired flight ticket (a departure date and a departure airport) and purchaser information (a name and a contact address), but also an input column 410 concerning the redemption of a flight ticket. In the example, the input column 410 includes a column 411 for an entry indicating whether product redemption will be permitted, a column 412 for entries establishing redemption conditions, and a column 413 for contact method entries. The points provided for the input columns 411, 412 and 413 are the points awarded for a redemption. As is described above, when a flight ticket is redeemed, points are calculated based on points awarded for mileage, and are provided for a purchaser who has agreed to permit product redemption.

The interface screen in FIG. 4 is merely an example; the structures that may be used are not limited to the one that is shown. The input column 410 concerning the redemption of a flight ticket is requisite; however, the other input entries are not limited to those shown in FIG. 4. To prepare an interface screen for the purchase of flight tickets, an arbitrary structure can be used, while taking into account the type of product offered and the operating convenience afforded a user.

A user (purchase applicant) enters required information by employing the interface screen shown in FIG. 4, which is displayed by the user terminal 60, and issues a request for the purchase of a flight ticket. The purchase request issued through the user terminal 60 is transmitted via the ticket sales system 10 to the ticket management system 30. When the pertinent flight ticket is available, notification to that effect is returned to the user, who can then purchase the flight ticket.

As is described above, the user requests that the special operator operate the special terminal 20 to purchase the flight ticket. In this case, the special terminal 20 submits a request directly to the ticket management system 30, without going through the intervening ticket sales system 10, and issues the flight ticket. For the input interface of the special terminal 20, an arbitrary structure can be used, although in this case also, entries concerning the redemption of a flight ticket are requisite.

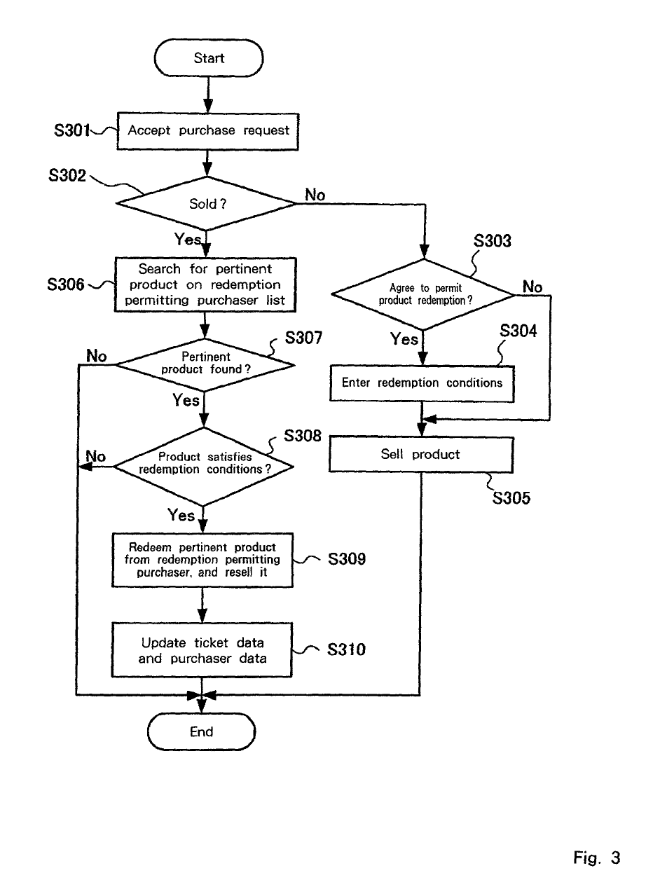

The processing for this embodiment will now be described. FIG. 3 is a flowchart for explaining the processing for the sale and the management procedures provided for a flight ticket in accordance with the embodiment. While referring to FIG. 3, first, the ticket sales system 10 or the special terminal 20 accepts a request for the purchase of a flight ticket (step 301). This purchase request is thereafter transmitted to the ticket management system 30.

Based on the received purchase request, the ticket management system 30 examines the stock on hand to determine whether the pertinent flight ticket is available. When the pertinent flight ticket is available in stock, the flight ticket is sold in accordance with the purchase request (steps 302 to 305), while the purchase applicant makes an entry indicating whether he or she will agree to permit redemption of the flight ticket, and if the entry is affirmative, also enters redemption conditions (steps 303 and 304).

After the flight ticket has been sold, data concerning the flight ticket (ticket data) and data concerning the purchaser (including the redemption permission information) are updated, and the processing is terminated (step 310).

When at step 302 the pertinent flight ticket is not available in stock, the ticket management system 30 searches the purchaser database 50 to determine whether the purchasers of like flight tickets are included in the redemption permitting purchaser list 51 (step 306). When a purchaser who obtained a like flight ticket is found on the redemption permitting purchaser list 51, the ticket management system 30 examines the ticket stock to determine whether a replacement flight ticket that satisfies the redemption conditions can be provided for the purchaser who agreed to permit product redemption (steps 307 and 308). For example, when the redemption conditions are that a flight should depart on the same day but no airline is designated, the ticket management system 30 examines the ticket stock for other airlines to determine whether a flight ticket is available for a same day departure.

When a replacement flight ticket that satisfies the redemption conditions is found, the ticket management system 30 redeems the flight ticket from the purchaser agreed to permit product redemption and provides the purchaser the replacement flight ticket. Thereafter, the redeemed flight ticket is sold to the purchase applicant (step 309).

When the flight ticket is sold, data concerning the flight ticket (ticket data) and data concerning the purchaser (including information concerning the redemption) are updated, and the processing is terminated (step 310).

When, at step 307, none of the purchasers who purchased pertinent flight tickets are on the redemption permitting purchaser list 51, or when, at step 308, a replacement flight ticket that satisfies the redemption conditions is not available, the pertinent flight ticket can not be sold to the purchase applicant. Therefore, the ticket management system 30 notifies the purchase applicant that the flight tickets are sold out, and the processing is terminated.

In this embodiment, when a flight ticket is redeemed, privileges are provided a purchaser who agreed to permit product redemption in accordance with the redemption points that were established. These redemption points may also be dynamically set as time elapses.

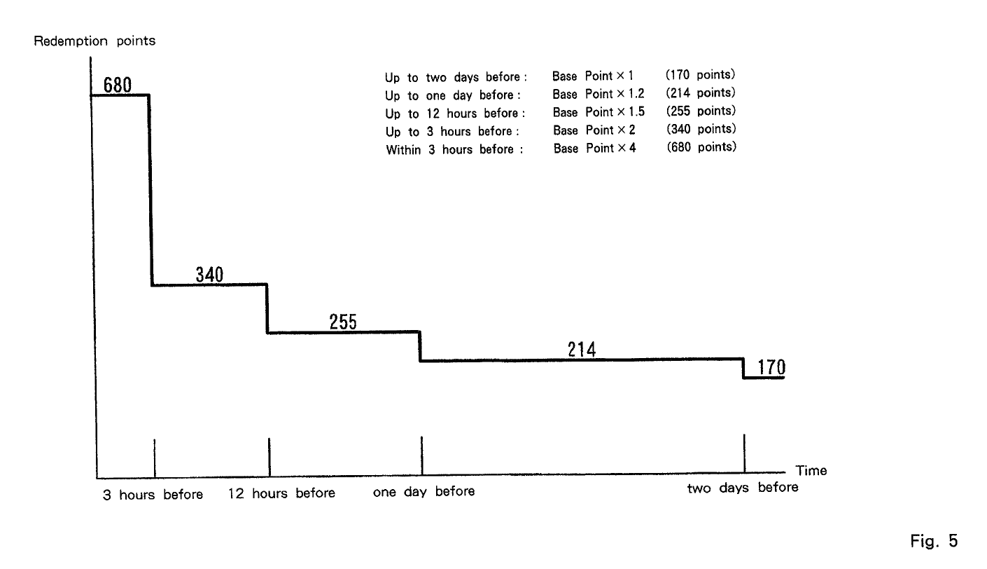

FIG. 5 is a diagram showing an example wherein the redemption points displayed on the interface screen shown in FIG. 4 are changed as time elapses.

As is shown in FIG. 4, when the redemption conditions are designated, for the redemption points (base points), 170 points (=100+20+50) are established as a reference. In FIG. 5, if a flight ticket is redeemed more than two days prior to the departure date, the reference base points are provided for a purchaser who has agreed to permit product redemption, and if it is redeemed within a period extending from two days before to one day prior to the departure date, 214 points, 1.2 times the base points, are provided. While if the flight ticket is redeemed within a period extending from one day before to 12 hours prior to the departure, 255 points, 1.5 times the base points, are provided, and if it is redeemed within a period 12 hours before to three hours prior to the departure, 340 points, twice the base points, are provided. Finally, if the flight ticket is redeemed within three hours of the departure, 680 points, four times the base points, are provided.

The above processing is performed through time management provided, for example, by the ticket management system 30.

The closer to the effective date a reserved ticket, such as a flight ticket, is redeemed, the greater is the inconvenience to which a purchaser who has agreed to permit product redemption is put. Thus, to recompense the purchaser for the inconvenience imposed by the redemption, the redemption points increase as the effective date is neared.

The settings for the redemption point changes in FIG. 5 are merely examples, and a vender can establish arbitrary redemption points in accordance with product types and the privileges that are to be provided in return for a redemption.

When the redemption points change as time elapses, a user (a purchaser who agreed to permit product redemption) may employ the user terminal 60 to ascertain the current redemption point status. That is, a purchaser may employ the user terminal 60 to query the ticket management system 30 regarding a flight ticket he or she has contracted for, and the ticket management system 30 will provide the purchaser data concerning the current redemption point total. Thus, a purchaser who granted product redemption permission can immediately ascertain how many redemption points will be awarded if a redemption occurs. Further, so long as a purchaser can obtain, through the user terminal 60, redemption point values as they change over time, when a purchaser purchases a product, the purchaser may defer making an entry concerning redemption permission until he or she has observed the changes in the redemption points and has determined from that whether to permit product redemption.

As is described above, the present invention can be applied for the flight ticket sales management system as explained in the embodiment, and also for the sale and management of a variety of other tickets, such as movie tickets and sports event tickets. Further, the present invention can also be applied for hotel reservations. In this case, instead of the ticket sales and management system, the reservation and management system is employed. That is, the ticket sales system 10 is replaced by a reservation acceptance system, the ticket management system 30 is replaced by a reservation management system, and the ticket database 40 and the purchaser database 50 are replaced by a reservation database. When a reservation is made, the replacement conditions for a facility change (a room, etc.) are registered in the same manner as are redemption conditions. Then, if a reservation request for the same facilities is received and substitute facilities are available that satisfy the replacement conditions, the reserved facilities are changed. The method for obtaining and managing the information required for this process is essentially the same as that employed for the above described sales management system.

In the above embodiment, a flight ticket that has been sold once is redeemed from a purchaser, and is then sold to a purchase applicant. However, the product may be exchanged for the replacement without being redeemed, and the exchanged product may be provided for another purchase applicant.

Advantages of the Invention

As is described above, according to the invention, it is easy for a vendor to redeem a product from a purchaser. Thus, management of the sale of products can be efficiently performed.

In addition, a purchaser who requests that only modest conditions be established when purchasing a product can obtain a predetermined privilege by exchanging the product for an equivalent replacement product.

Description of the Symbols

10: Ticket sales system

20: Special terminal

30: Ticket management system

40: Ticket database

50: Purchaser database

51: Redemption permitting purchaser list

60: User terminal

1. A sales management system comprising:
a sales server for vending products via a communication network; and
purchase terminals for accessing said sales server via a communication network and transmitting product purchase requests,
wherein for a purchase terminal transmits, to said sales server, not only a product purchase request but also a purchaser issued product redemption status statement permitting or not permitting product redemption,
wherein said sales server manages information concerning the terms of a sale of a product, to include a product redemption status statement, and
wherein when said sales server receives, from a purchaser, a predetermined purchase request for a product said sales server had previously agreed to supply, in response to a previous purchase request received from a previous purchase terminal, to a previous purchaser who, in an affiliated product redemption status statement, agreed to permit product redemption, said sales server can redeem said product from said previous purchaser and supply said product to said purchaser who has submitted said predetermined purchase request.

2. The sales management system according to claim 1, wherein said previous purchase terminal transmits to said sales server not only said statement in which said previous purchaser agrees to permit product redemption, but a listing of conditions governing the redemption of said product; and wherein, after said conditions governing the redemption of said product have been satisfied, said sales server redeems said product.

3. A sales management system comprising:
a management server for managing product sales information; and
product sales terminals for transmitting to said management server, via a communication network, requests for the purchase of products to ascertain the sales status of said products, and for selling said products when said products are available,
wherein said product sales terminals transmit to said management server not only said product purchase requests but also purchaser issued product redemption status statements agreeing or not agreeing to permit product redemption,
wherein said management server manages said product redemption status statements received from said product sales terminals, and
wherein when said management server receives, from a product sales terminal, a predetermined purchase request submitted by a purchase applicant for a product said sales management server has previously agreed to supply, in response to a purchase request, to a previous purchaser, who agreed to permit product redemption, said management server redeems said product from said previous purchaser, and is ready to sell said product to said purchase applicant who issued said predetermined purchase request.

4. The sales management system according to claim 3, wherein said product sales terminals transmit, to said management server, not only statements in which purchasers agree to permit product redemption, but also conditions governing the redemption of products; and wherein, after said conditions governing the redemption of said products have been satisfied, said management server redeems said products.

5. A sales management server comprising:
purchase request acceptance means for accepting product purchase requests via a communication network; and
management means for managing the sale of products,
wherein said sales management server, upon acceptance of a product purchase request from a purchase applicant, inquires of said purchase applicant whether said purchase applicant will agree to permit the redemption of a product for which said purchase request was submitted, and
wherein when said sales management server receives a predetermined product purchase request from a purchase applicant for a product said sales management server has previously agreed to supply, in response to a purchase request, to a previous purchaser, who agreed to permit product redemption, said management means redeems said product from said previous purchaser and supplies said product to said purchase applicant who issued said predetermined purchase request.

6. The sales management server according to claim 5, wherein said purchase request acceptance means receives not only a reply to an inquiry to determine whether said purchaser will agree to permit product redemption, but also conditions governing the redemption of said product; and wherein, after said conditions governing the redemption of said product have been satisfied, said management means redeems said product.

7. The sales management server according to claim 5, wherein, when said product is redeemed, predetermined privileges are provided for said purchaser who permitted product redemption, and said management means manages information concerning said privileges.

8. The sales management server according to claim 7, wherein said management means dynamically changes said information concerning said privileges provided in accordance with predetermined conditions.

9. A sales management server for managing the sale of products comprising:
storage means for storing information indicting whether a purchaser of a product has agreed to permit product redemption; and
management means for receiving, via a communication network, information concerning a predetermined product purchase request, and for, based on the information stored said storage means when it is ascertained that a product for which said predetermined purchase request was submitted is a product for which a purchaser has agreed to permit product redemption, redeeming said product from said purchaser.

10. The sales management server according to claim 9, wherein said storage means stores not only said information indicating that a purchaser has agreed to permit product redemption, but also conditions governing the redemption of said product; and wherein, after said conditions for governing the redemption of said product have been satisfied, said management means redeems said product.

11. A sales management server comprising:
purchase request acceptance means for accepting, via a communication network, product purchase requests; and
management means for managing the sale of products,
wherein when said purchase request acceptance means accepts a product purchase request, said purchase request acceptance means inquires of the purchase applicant, who issued said purchase request, whether said purchase applicant will agree to permit the substitution, for a product for which said purchase request was submitted, of a different product, and accepts conditions governing the provision of a replacement product, and
wherein when a product for which a predetermined purchase request is submitted and accepted by said purchase request acceptance means has already been provided for a purchaser who has agreed to permit a product exchange, and when said management means determines that a replacement product, which satisfies said conditions governing a product exchange, is available for supply to said purchaser, said management means exchanges said replacement product for the product originally obtained by said purchaser.

12. A sales server comprising:
purchase request acceptance means for accepting, via a communication network, product purchase requests; and
sales means for selling products via a communication network upon receipt of said product purchase requests,
wherein said purchase request acceptance means receives, from a user, not only a product purchase request but also a product redemption status statement permitting or not permitting product redemption.

13. The sales server according to claim 12, wherein, regardless of whether said product is redeemed, predetermined privileges are provided for said purchaser who permitted product redemption, and wherein management means is further provided for managing information concerning said privileges.

14. A reservation management server comprising:
reservation acceptance means for accepting reservations via a communication network; and
management means for managing the status of reservations,
wherein upon acceptance of a request for a reservation said reservation acceptance means inquires of the submitter of said request whether said submitter will agree to permit a reservation change, and accepts conditions governing the agreement to permit a reservation change,
wherein when the object of a reservation accepted by said reservation acceptance means is the same as that for a specific reservation that was previously approved for an applicant who agreed to permit a reservation change, and when said conditions governing said reservation change can be satisfied, said management means changes the object of said reservation made by said applicant.

15. A product purchase terminal comprising:
purchase request transmission means for transmitting a purchase request to a sales management system for accepting, via a communication network, a product purchase request;
input means for entering data required to issue said purchase request; and
output means for presenting information required for the issue of said purchase request,
wherein said input means accepts identification information indicating that a request to redeem a product for which said purchase request is submitted will be complied with, and
wherein said purchase request transmission means will transmit, to said sales management system, said identification information accepted by said input means.

16. The product purchase terminal according to claim 15, wherein said input means accepts conditions for the redemption of a product, and said purchase request transmission means transmits to said sales management system said redemption conditions accepted by said input means.

17. The product purchase terminal according to claim 15, wherein, when said product is redeemed from a purchaser whom said identification information verifies has agreed to permit said redemption request, a predetermined privilege is provided for said purchaser; and wherein said output means presents a privilege to be provided, in accordance with said redemption conditions entered by said input means.

18. A product sales method comprising the steps of:
submitting an inquiry, via a communication network, to determine whether permission for a redemption request will be given when a purchase request for a product is accepted;
accepting a response to said inquiry and selling said product;
complying with and obtaining said product when a different purchase request is accepted, by redeeming said product for which redemption permission has been granted by a purchaser who responded to the redemption request inquiry; and
providing said product that is redeemed to a purchase applicant who issued said different purchase request.

19. The product sales method according to claim 18, wherein said step of inquiring whether said request for redemption permission will be granted includes the step of:
setting conditions for the redemption of a product, and wherein said step of redeeming said product includes the steps of:
examining whether conditions for the redemption of said product have been satisfied; and
redeeming said product when said product redemption conditions have been satisfied.

20. The product sales method according to claim 18, wherein said step of inquiring whether said request for redemption will be granted includes the step of:
setting, as a condition for the redemption of a product, the provision of a replacement product that satisfies predetermined conditions, and wherein said step of redeeming said product includes the steps of:
determining whether said replacement product that satisfies said predetermined conditions can be provided, and
redeeming said product when said replacement product that satisfies said predetermined conditions can be provided.

21. A storage medium on which a computer-readable program is stored by computer input means, said computer-readable program permitting said computer to perform:
a process for accepting, via a communication network, a product purchase request;
a process for inquiring, of a purchase applicant who issued said product purchase request, whether said purchase applicant will agree to permit the redemption of a product for which said purchase request is submitted; and
a process for, when the purchase of said product has already been processed for sale to a purchaser who, in response to an inquiry, has agreed to permit the redemption of said product, redeeming said product from said purchaser.
